(19) United States
(12) Patent Application Publication
(10) Pub. No.: US 2018/0100344 A1
(43) Pub. Date: Apr. 12, 2018

(54) DRIVE ASSEMBLIES FOR PARTITION SYSTEMS AND RELATED PARTITION SYSTEMS

(71) Applicant: Won-Door Corporation, Salt Lake City, UT (US)

(72) Inventors: Tracy M. Knight, Kearns, UT (US); R. Scott Smart, Sandy, UT (US); Duane O. Hall, Sandy, UT (US)

(21) Appl. No.: 15/288,710

(22) Filed: Oct. 7, 2016

(51) Int. Cl. E05F 15/605; F16H 1/20; E06B 5/16; E06B 3/46; E06B 3/48; E05F 15/643; E06B 3/94; E05D 15/26

(52) U.S. Cl. CPC E05F 15/605; F16H 1/203; E06B 5/16; E06B 3/4654; E05Y 2900/142; E05F 15/643; E06B 3/94; E05D 15/26; E06B 3/481

(57) ABSTRACT

Drive assemblies for partition systems may include a motor and a power transmission mechanism operably coupled to a drive shaft of the motor. The power transmission mechanism may include a first bevel gear rotatable by the drive shaft and a second bevel gear positioned for engagement with the first bevel gear. The second bevel gear may include an axis of rotation oriented at least substantially perpendicular to an axis of rotation of the first bevel gear. A disengagement mechanism may be coupled to at least one of the first bevel gear or the second bevel gear and configured to selectively engage and disengage the first bevel gear and the second bevel gear.

### FIELD

This disclosure relates generally to drive assemblies for movable partition systems configured to subdivide a space, and optionally provide a security or fire barrier, utilizing a folding partition. More specifically, disclosed embodiments relate to drive assemblies for partitions enabling, for example, selective disengagement and locking of drive members, and usable in a greater variety of configurations and orientations with a greater variety of corresponding track configurations than existing drive assemblies.

### BACKGROUND

Movable partitions are utilized in numerous situations and environments for a variety of purposes. Such partitions may include, for example, a foldable or collapsible door configured to enclose or subdivide a room or other area. Often, such partitions may be utilized simply for purposes of versatility in being able to subdivide a single large room into multiple smaller rooms. The subdivision of a larger area may be desired, for example, to accommodate multiple groups or meetings simultaneously. In other applications, such partitions may be utilized for noise control depending, for example, on the activities taking place in a given room or portion thereof.

Movable partitions may also be used to provide a security barrier, a fire barrier, or both a security barrier and a fire barrier. In such a case, the partition barrier may be configured to automatically close upon the occurrence of a predetermined event such as the actuation of an associated alarm. For example, one or more accordion or similar folding-type partitions may be used as a security barrier, a fire barrier, or both a security barrier and a fire barrier wherein each partition is formed with a plurality of panels connected to one another with hinges. The hinged connection of the panels allows the partition to fold and collapse into a compact unit for purposes of storage when not deployed. The partition may be stored in a pocket formed in the wall of a building when in a retracted or folded state. When the partition is deployed to subdivide a single large room into multiple smaller rooms, secure an area during a fire, or for any other specified reason, the partition may be extended along an overhead track, which is often located above the movable partition in a header assembly, until the partition extends a desired distance across the room.

When deployed, a leading end of the movable partition, often defined by a component known as a lead post, complementarily engages another structure, such as a wall, a post, or a lead post of another door.

Automatic extension and retraction of the movable partition may be accomplished through the use of a motor located in a pocket formed in the wall of a building in which the movable partition is stored when in a retracted or folded state. The motor, which remains fixed in place within the pocket, may be used to drive extension and retraction of the movable partition. A motor for automatically extending and retracting a movable partition may also be mounted within the movable partition itself, such that the motor travels with the movable partition as the movable partition is extended and retracted using the motor. Mechanisms enabling both automatic and manual extension and retraction of partitions are disclosed in U.S. Pat. No. 9,353,568, issued May 31, 2016, to Knight et al., the disclosure of which is incorporated herein in its entirety.

### BRIEF SUMMARY

In some embodiments, drive assemblies for partition systems may include a motor and a power transmission mechanism operably coupled to a drive shaft of the motor. The power transmission mechanism may include a first bevel gear rotatable by the drive shaft and a second bevel gear positioned for engagement with the first bevel gear. The second bevel gear may include an axis of rotation oriented at least substantially perpendicular to an axis of rotation of the first bevel gear. A disengagement mechanism may be coupled to at least one of the first bevel gear or the second bevel gear and configured to selectively engage and disengage the first bevel gear and the second bevel gear.

In other embodiments, partition systems may include a track and a partition suspended from, and slidable along, the track, the partition including panels interconnected by hinges. A drive assembly may be operably connected to the partition to extend and retract the partition. The drive assembly may include a motor and a power transmission mechanism operably coupled to a drive shaft of the motor. The power transmission mechanism may include a first bevel gear directly rotatable by the drive shaft and a second bevel gear positioned for engagement with the first bevel gear. The second bevel gear may include an axis of rotation oriented at least substantially perpendicular to an axis of rotation of the first bevel gear. A disengagement mechanism may be configured to selectively engage the first bevel gear and the second bevel gear and to selectively disengage the first bevel gear from the second bevel gear. The disengagement mechanism may include an electric drive including an output shaft and a lever member secured to the output shaft of the electric drive at a first end thereof and to the first bevel gear at a second, opposite end thereof, the lever member rotatable about a fulcrum. The lever member may be configured to selectively move the first bevel gear in a direction at least substantially parallel to the axis of rotation of the first bevel gear responsive to movement of the output shaft.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a perspective side view of a partition system;

FIG. 2 is a simplified top view of a portion of the partition system of FIG. 1;

FIG. 3 is a front view of a drive assembly for a partition;

FIG. 4 is a partial cutaway front view of the drive assembly of FIG. 3;

FIG. 5 is a side view of the drive assembly 150 of FIG. 3.

FIG. 6 is a cross-sectional top view of a portion of the drive assembly of FIG. 3

FIG. 7 is a partial cutaway top view of the drive assembly of FIG. 3;

FIG. 8 is a perspective side view of another embodiment of a drive assembly for a movable partition;

FIG. 9 is a partial front view of the drive assembly of FIG. 8;

FIG. 10 is a partial cutaway top view of the drive assembly of FIG. 8;

FIG. 11 is a perspective view of yet another embodiment of a drive assembly for a movable partition;

FIG. 12 is a side view of the drive assembly of FIG. 11

FIG. 13 is a partial cutaway perspective side view of the drive assembly of FIG. 11;

FIG. 14 is a perspective side view of still another embodiment of a drive assembly 270 for a movable partition;

FIG. 15 is a front view of the drive assembly of FIG. 14; and

FIG. 16 is a partial cutaway side view of the drive assembly of FIG. 14.

### DETAILED DESCRIPTION

The illustrations presented in this disclosure are not meant to be actual views of any particular movable partition system, drive assembly, or component thereof, but are merely idealized representations employed to describe illustrative embodiments. Thus, the drawings are not necessarily to scale.

Disclosed embodiments relate generally to drive assemblies for partitions enabling, for example, selective disengagement and locking of drive members, and usable in a greater variety of configurations and orientations with a greater variety of corresponding track configurations than existing drive assemblies. More specifically, disclosed are embodiments of drive assemblies including power transmission mechanisms having bevel gears in varying numbers, locking mechanisms to selectively lock rotation of the gears, and modular construction enabling the same components to be rearranged, combined with other accessories, and reoriented for use in various use conditions.

As used in this disclosure, the terms “top,” “bottom,” “upper,” and “lower” are used for the sake of convenience only, and are not meant to limit the orientation and positioning of a device as installed. Rather, they describe the relative positioning in the figures, and are used to clearly describe illustrative embodiments.

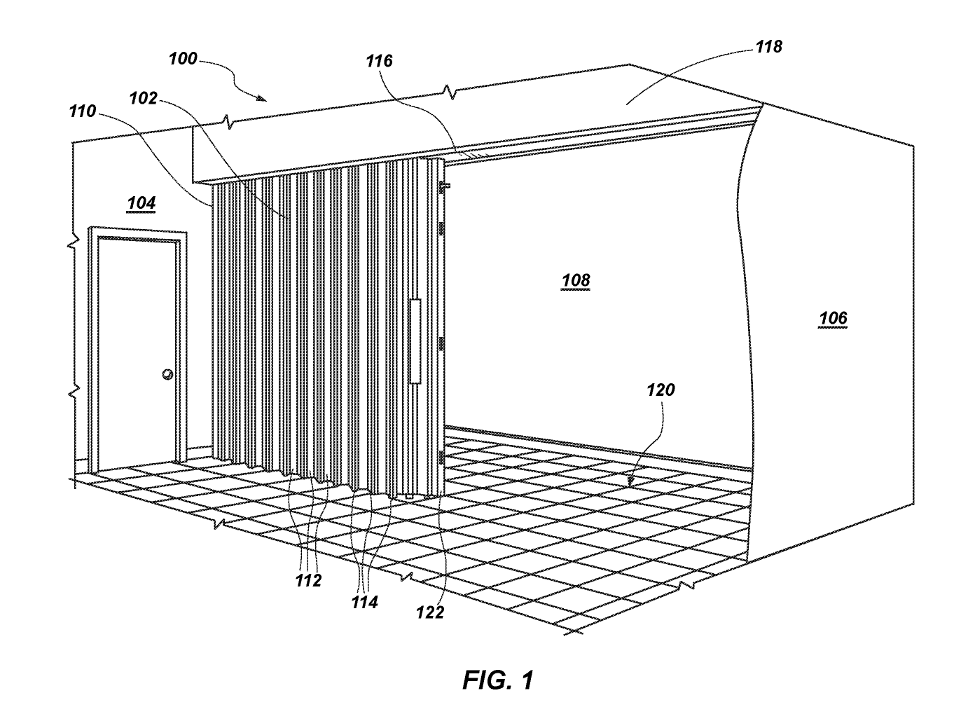

Referring to FIG. 1, FIG. 1 a perspective side view of a partition system 100 is shown. The partition system 100 may include, for example, a partition 102 configured to extend and retract between an extended state in which the partition 102 may extend from a first wall 104 toward a second wall 106 to subdivide a space 108 or otherwise form a barrier between the first and second walls 104 and 106 and a retracted state in which the partition 102 may be located at least partially (e.g., completely) within a pocket 110 extending from the first wall 104 away from the space 108. The partition 102 may be configured to extend and retract automatically in response to a detected environmental condition within the building (e.g., the presence of smoke or exceeding a temperature threshold, indicating the presence of a fire), in response to a user input, and/or in accordance with a predetermined, stored schedule. In some embodiments, the partition 102 may be configured to extend and retract manually by a user pushing or pulling the partition 102 as a default configuration, in response to a detected environmental condition (e.g., the presence of a person proximate the partition 102, particularly when a fire has also been detected), or in response to a user input.

In some embodiments, the partition system 100, including the partition 102 thereof, may act as a fire barrier. A fire barrier system or assembly may present an impediment to the progress of fire, smoke, and heat. Thus, a fire barrier may retard or resist the deleterious effects of fire, smoke, and heat for a certain period of time. A number of standardized tests that evaluate the effectiveness of fire barrier assemblies have been developed for use in the building industry. These are published, for example, in the International Building Code (IBC), and by the National Fire Protection Association (NFPA), UNDERWRITERS LABORATORIES® (UL), and the American Society for Testing and Materials (ASTM), among others. Various agencies test fire barriers using these standardized tests, and assign ratings to fire barriers that indicate their effectiveness at slowing the progress of a fire. Barrier testing agencies include Intertek Testing Services, UL LLC (also known as UNDERWRITERS LABORATORIES®), Chiltern International Fire, Ltd., and Exova Warrington Certification (formerly known as Warrington Fire Research), among others. The partition system 100 may be rated according to at least a minimum rating for fire-resistant barriers in accordance with an approved testing agency. More specifically, the partition system 100 may achieve, for example, at least a 20-minute rating according to any of the testing methods disclosed in the Tenth Edition of ANSI/UL 10B-2015 document titled, “STANDARD FOR SAFETY Fire Tests of Door Assemblies.”

The partition 102 may include panels 112 interconnected to one another by hinges 114 enabling the panels 112 to fold in a plicated (e.g., accordion-like) manner to extend and retract the partition 102. The partition 102 may be suspended from a track 116, which may be located, for example, in a header assembly 118 or embedded within a ceiling structure of the building. The partition 102 may extend longitudinally (i.e., in an at least substantially vertical direction) from proximate the track 116 to proximate the floor 120. A lead post 122 may be located at an end of the partition 102 opposite the pocket 110 when the partition 102 is in the extended position. The lead post 122 may be configured to engage with a door striker located proximate the second wall 106 or another lead post of a mating partition extending from the second wall 106 to meet and mate with the partition 102 in the space 108. The lead post 122 may be movable laterally (i.e., in an at least substantially horizontal direction), which may cause corresponding expansion and retraction of the partition 102 by relative movement of the panels 112 about the hinges 114.

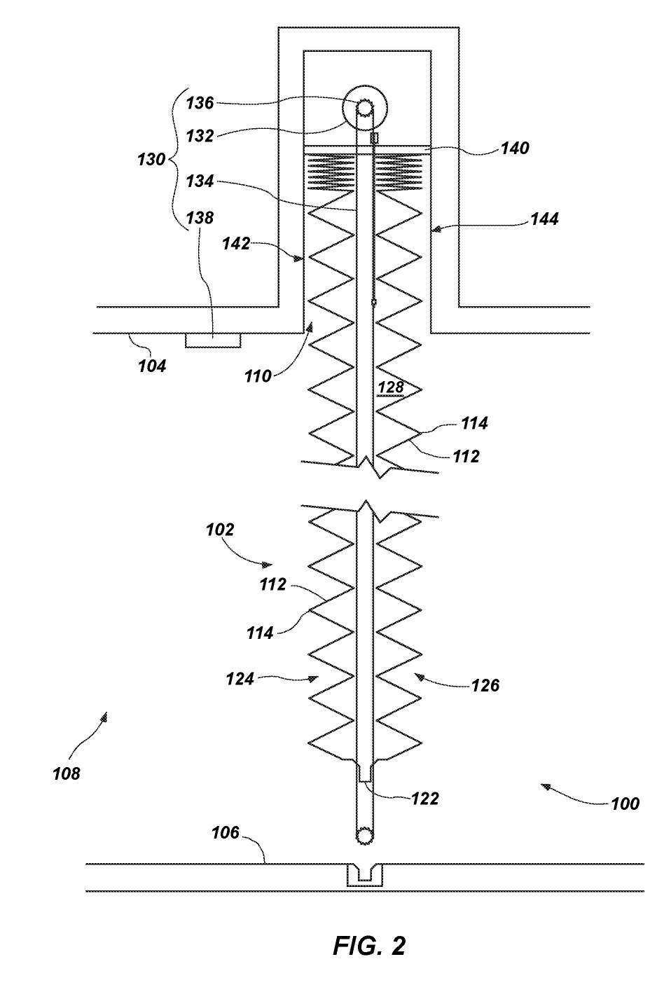

FIG. 2 is a simplified top view of a portion of the partition system 100 of FIG. 1. In some embodiments, such as that shown in FIG. 2, the partition 102 may include multiple sheets 124 and 126 of interconnected panels 112 and hinges 114. For example, the partition 102 may include a first sheet 124 of interconnected panels 112 and hinges 114 extending laterally from within the pocket 110 to the lead post 122 and a second sheet 126 spaced horizontally from, and extending at least substantially parallel to, the first sheet 124 from within the pocket 110 to the lead post 122. The first and second sheets 124 and 126 may be connected to a floating jamb 140 within the pocket 110. The floating jamb 140 may extend horizontally from a first sidewall 142 on a first side of the pocket 110 to a second sidewall 144 on an opposite side of the pocket 110 to form a barrier between the subdivided portions of the space 108. The floating jamb 140 may be configured to slide laterally within the pocket 110 to accommodate extension and retraction of the partition 102 while maintaining a barrier between the subdivided portions of the space 108 beyond the sheets 124 and 126 of the partition 102. An interior space 128 may be located horizontally between the sheets 124 and 126 and between the lead post 122 and the floating jamb 140.

The partition system 100 may include a drive system 130 configured to drive automatic extension and retraction of the partition 102. The drive system 130 may include, for example, a motor 132 configured to mechanically power the movement of the partition 102, a continuous drive member 134 (e.g., a chain, belt) configured to transfer power from the motor 132 to the partition 102, a drive shaft 136 (e.g., a sprocket, gear, roller) operatively connecting the continuous drive member 134 to the motor 132 to transfer motive power from the motor to the continuous drive member 134, and a control system 138 operatively connected to the motor 132 to control the activation, speed, power, and direction of the output of the motor 132.

In some embodiments, such as that shown in FIG. 2, the motor 132 and drive shaft 136 may be fixed to the building structure (e.g., within the pocket 110) and the partition 102 may be secured to the continuous drive member 134, such that movement of the continuous drive member 134 driven by the motor 132 and drive shaft 136 may cause the partition 102 to extend and retract responsive to movement of the continuous drive member 134. In other embodiments, the motor 132 and drive shaft 136 may be fixed to the partition 102 and the continuous drive member 134 may be fixed to the building structure, such that rotation of the drive shaft 136 driven by the motor 132 may cause the partition 102 to extend and retract responsive to movement of the drive shaft 136 along the continuous drive member 134.

Drive systems 130 in accordance with this disclosure may include drive assemblies, which may encompass the motor 132, drive shaft 136, and other components that may render the resulting drive assemblies usable with a greater variety of configurations for partition systems 100, usable in a greater variety of orientations and changeable configurations, lockable to restrict (e.g., prevent) movement of the partition 102 when desired, disengagable to enable freestanding manual movement of the partition 102 independent of movement, or lack thereof, of the drive shaft 136.

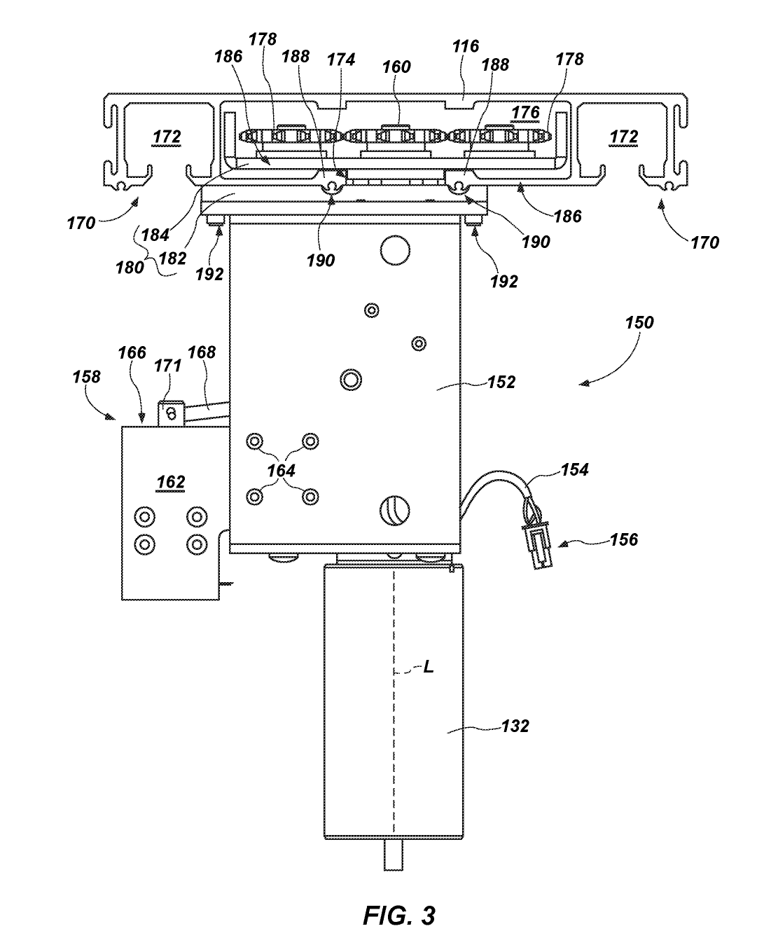

FIG. 3 is a front view of a drive assembly 150 for a movable partition 102 (see FIGS. 1, 2). The drive assembly 150 may include a motor 132 supported by a case 152. More specifically, the motor 132 may extend from within the case 152, through the case 152, to an exterior of the case 152. In the embodiment shown in FIG. 3, a longitudinal axis L of the motor 132, which may extend at least substantially parallel to an axis of rotation of the drive shaft 136 (see FIG. 2) of the motor 132, may be oriented at least substantially vertically when the drive assembly 150 is positioned for use with the partition system 100 (see FIGS. 1, 2).

The case 152 may be located vertically above a depending portion of the motor 132 located outside the case 152. The case 152 may be sized and shaped to at least partially contain other components of the drive assembly 150, such as, for example, power transmission mechanisms, locking mechanisms, disengagement mechanisms 158, and wiring 154. The wiring 154 may extend from within the case 152, through one or more openings in the case 152, to an exterior of the case 152 for operational connection to, for example, the control system 138 (see FIG. 2), a power source, etc. The wiring 154 may include a connector 156 at an exposed end thereof to facilitate operational connection. The connector 156 may be, for example, a multiple-pin electrical connector configured to provide electrical and mechanical connection between the electronic components of the drive assembly 150 and another device (e.g., the control system 138, a power source).

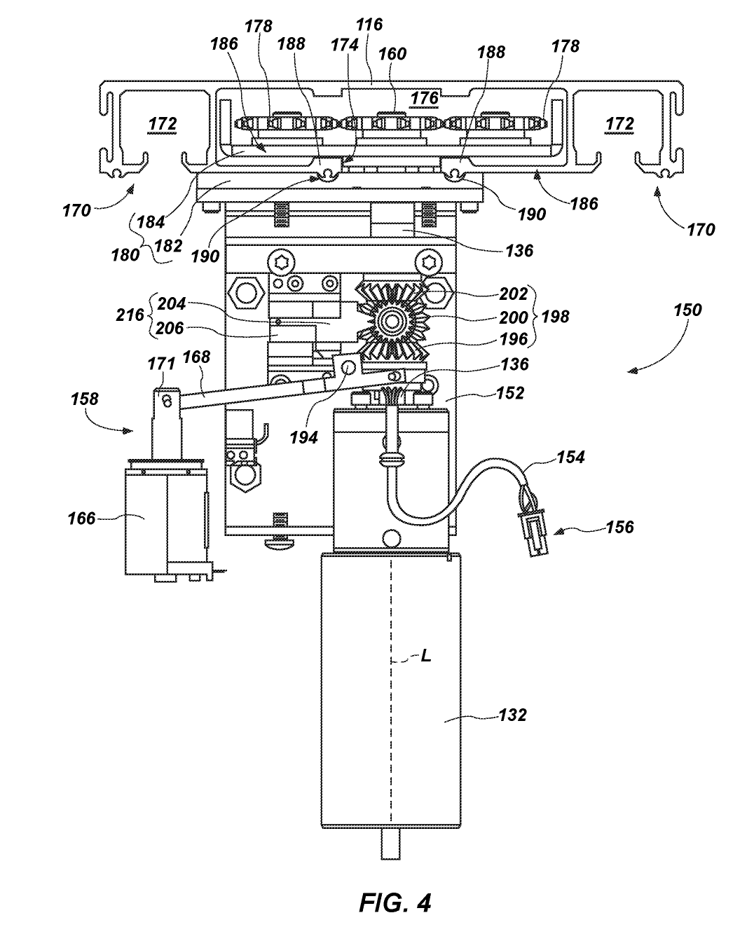

The disengagement mechanism 158 may be configured to disengage the drive shaft 136 (see FIG. 2) of the motor 132 from a power transmission mechanism configured to transmit motive power from the drive shaft 136 to a drive member 160 of the drive assembly 150, as described in greater detail in connection with FIG. 4. The disengagement mechanism 158 may include a dedicated case extension 162 secured to the case 152 utilizing attachment hardware 164 (e.g., screws, bolts, rivets) and extending from within the case 152 to the exterior of the case 152. The case extension 162 may support a controllable electric drive 166 at least partially therein. The controllable electric drive 166 may be, for example, a solenoid. The electric drive 166 may include an output shaft 171 connected to a lever member 168, and activation and deactivation of the electric drive 166 may cause the output shaft 171 to move vertically and cause corresponding movement of the lever member 168. The lever member may disengage the drive shaft 136 (see FIG. 2) from a power transmission mechanism, as described in greater detail in connection with FIG. 4.

The case 152 may be suspended from, and supported by, the track 116. The track 116 may be an elongate structure sized to extend laterally from the first wall 104 to the second wall 106 (see FIGS. 1, 2). The track 116 may include downward-facing, substantially “C” shaped members 170 at the sides thereof. The “C” shaped members 170 may be positioned to be proximate the sidewalls 142 and 144 (see FIG. 2) of the pocket 110 when the track 116 is installed. The “C” shaped members 170 may form channels 172 at the periphery of the track 116 configured to receive rollers to suspend the partition 102 (see FIGS. 1, 2) from the track 116. The track 116 may further include a central, downward facing opening 174 in communication with a central channel 176 extending along the track 116. The central channel 176 may be sized and shaped to receive the drive member 160, continuous drive member 134 (see FIG. 2), tension members 178, and support structure 180 for the drive assembly 150 at least partially therein.

The support structure 180 may include a bottom plate 182 located vertically above the case 152 and a top plate 184 located within the central channel 176. Retaining portions 186 of the track 116 may be located (e.g., clamped) between the bottom plate 182 and top plate 184, and may extend horizontally from the “C” shaped members 170 inward toward the opening 174, to secure the drive assembly 150 to the track 116. The retaining portions 186 may include protrusions 188 extending vertically toward the case 152, and the bottom plate 182 may include grooves 190 extending from the retaining portion 186 toward the case 152, such that the protrusions 188 may be positioned at least partially into the grooves 190 to secure the drive assembly 150 to, and orient the drive assembly 150 relative to, the track 116. The drive member 160 and tension members 178 to be engaged with the continuous drive member 134 (see FIG. 2) may be rotatably connected to the top plate 184, and may be positioned within the central channel 176.

When suspending the drive assembly 150 from the track 116, the grooves 190 in the bottom plate 182 may be aligned with the protrusions 188 in the retaining portions 186 of the track 116. The top plate 184 and drive member 160 and tension members 178 supported thereon may be inserted into the central channel 176 by sliding the drive assembly 150 along the guiding protrusions 188 with the grooves 190 aligned therewith. Attachment hardware 192 may then clamp the retaining portions 186 of the track 116 between the bottom and top plates 182 and 184 to suspend the drive assembly 150 from, and secure the drive assembly 150 to, the track 116.

FIG. 4 is a partial cutaway front view of the drive assembly 150 of FIG. 3. In FIG. 4, a portion of the case 152 has been removed to reveal an interior of the case 152 and the components contained therein, as has the case extension 162 (see FIG. 3). As shown in FIG. 4, the lever 168 of the disengagement mechanism 158 may be rotatable about a fulcrum 194 fixed to the case 152. The fulcrum 194 may include, for example, a rod extending through the case 152 to be connected to the shaft 171 of the electric drive 166, the fulcrum 194 enabling the lever 168 to rotate about the fulcrum 194. An end of the lever 168 opposite the electric drive 166 may be secured to the drive shaft 136 of the motor 132. More specifically, the end of the lever 168 opposite the electric drive 166 may be pinned to a first power transmission member 196 of the drive shaft 136. The first power transmission member 196 may be, for example, a bevel gear (i.e., a gear having teeth extending at an oblique angle, such as a 45° angle, relative to an axis of rotation of the gear) exhibiting a frustoconical shape.

When the electric drive 166 is in an engaged state (e.g., an activated state), the output shaft 171 may be at a vertical nadir (e.g., the lowest point of travel), causing the lever 168 to lift the first power transmission member 196 upward toward the drive member 160. When the electric drive 166 is in a disengagement state (e.g., a default, deactivated state), the output shaft 171 may be at a vertical zenith (e.g., the highest point of travel), causing the lever to lower the first power transmission member 196 away from the drive member 160, disengaging it from a remainder of the power transmission mechanism 198 and enabling free, manual movement of the partition 102 (see FIGS. 1, 2). In other embodiments, the engagement state may be a default, deactivated state, and the disengagement state may require activation of the electric drive 166.

Activation and deactivation of the electric drive 166, causing corresponding disengagement and engagement of the first power transmission member 196 with the other components of the power transmission mechanism 198, may be controlled by the control system 138 (see FIG. 2). For example, the control system 138 (see FIG. 2) may automatically cause the electric drive 166 to enter or remain in the engaged state or the disengaged state responsive to a detected condition or a user input. More specifically, the control system 138 (see FIG. 2) may cause the electric drive 166 to enter or remain in the engaged state, for example, as a default condition, when fire, smoke, or heat above a predetermined threshold has been sensed by sensors operatively connected to the control system 138, or in response to a user input indicating that the partition 102 (see FIGS. 1, 2) should be extended or retracted. As additional, specific examples, the control system 138 (see FIG. 2) may cause the electric drive 166 to enter or remain in the disengaged state, for example, as an alternative default condition, when a person has been sensed proximate the partition 102 (see FIGS. 1, 2) during a fire, smoke, or heat event, or in response to a user input instructing the partition system 100 (see FIGS. 1, 2) to enable manual movement of the partition 102 (see FIGS. 1, 2).

When the electric drive 166 is in the engaged state, the first power transmission member 196 may be engaged with a second power transmission member 200. The second power transmission member 200 may be, for example, another bevel gear exhibiting a frustoconical shape. More specifically, teeth of the first power transmission member 196 may be engaged with teeth of the second power transmission member 200, such that rotation of the first power transmission member 196 causes corresponding rotation of the second power transmission member 200. An axis of rotation of the second power transmission member 200 may be at least substantially perpendicular to an axis of rotation of the first power transmission member 196 and to the longitudinal axis L of the motor 132. For example, the axis of rotation of the second power transmission member 200 may be oriented about 5° or less from perpendicular to the axis of rotation of the first power transmission member 196 and to the longitudinal axis L of the motor 132. More specifically, the axis of rotation of the second power transmission member 200 may be oriented about 1° or less from perpendicular to the axis of rotation of the first power transmission member 196 and to the longitudinal axis L of the motor 132. The second power transmission member 200 may be rotatably secured to a wall of the case 152. In some embodiments, such as that shown in FIGS. 3 and 4, the second power transmission member 200 may not directly power movement of another device or structure. Rather, the second power transmission member 200 may serve to transfer motive power from the first power transmission member 196 indirectly to the drive member 160.

In some embodiments, such as that shown in FIGS. 3 and 4, the power transmission mechanism 198 may include a third power transmission member 202 engaged with the second power transmission member 200. The third power transmission member 202 may be, for example, yet another bevel gear exhibiting a frustoconical shape. More specifically, teeth of the second power transmission member 200 may be engaged with teeth of the third power transmission member 202, such that rotation of the second power transmission member 200 causes corresponding rotation of the third power transmission member 202. An axis of rotation of the third power transmission member 202 may be at least substantially perpendicular to an axis of rotation of the second power transmission member 200 and/or at least substantially parallel to an axis of rotation of the first power transmission member 196 and to the longitudinal axis L of the motor 132 (e.g., to the drive shaft of the motor 132). The third power transmission member 202 may transmit rotational motive power to the drive member 160 via shaft 136 connecting the third power transmission member 202 to the drive member 160 through the case 152, bottom plate 182, and top plate 184.

A locking member 204 may be selectively engageable with the second power transmission member 200 to at least partially inhibit (e.g., prevent) rotation of the second power transmission member 200, and corresponding transmission of power to the partition 102 (see FIGS. 1, 2). The locking member 204 may include one or more teeth sized, shaped, and oriented to engage with teeth of the second power transmission member 200 to lock the power transmission mechanism 198. The locking member 204 may be secured to another electric drive 206 configured to move the locking member 204 between an engaged state in which the tooth or teeth of the locking member 204 are engaged with teeth of the second power transmission member 200 and a disengaged state in which the tooth or teeth of the locking member are spaced from the second power transmission member 200. The electric drive 206 may be configured to move the locking member 204 in a direction at least substantially perpendicular to the rotational axis of the second power transmission member 200 to place the locking member 204 in the engaged and disengaged states. The electric drive 206 may be supported by, and connected to, the case 152. The locking member 204 and electric drive 206 may cooperatively form a locking mechanism 216 to selectively inhibit (e.g., prevent) movement of the partition 102 (see FIGS. 1, 2).

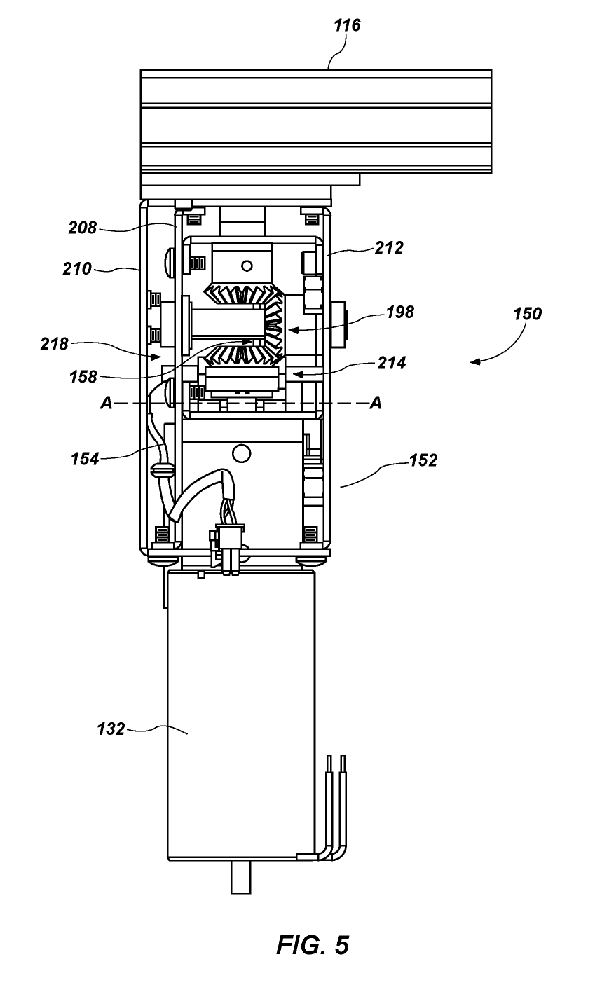

FIG. 5 is a side view of the drive assembly 150 of FIG. 3. The case 152 may include, for example, a divider 208 located laterally between sidewalls 210 and 212 of the case 152. The divider 208 may subdivide the interior of the case 152 into a component section 214 in which at least a portion of each of the disengagement mechanism 158, the power transmission mechanism 198, the locking mechanism 216 (see FIG. 4) may be located and a wire-routing section 218 in which at least a portion of the wiring 154 may be located to facilitate cable management and provide an additional surface to which components may be secured.

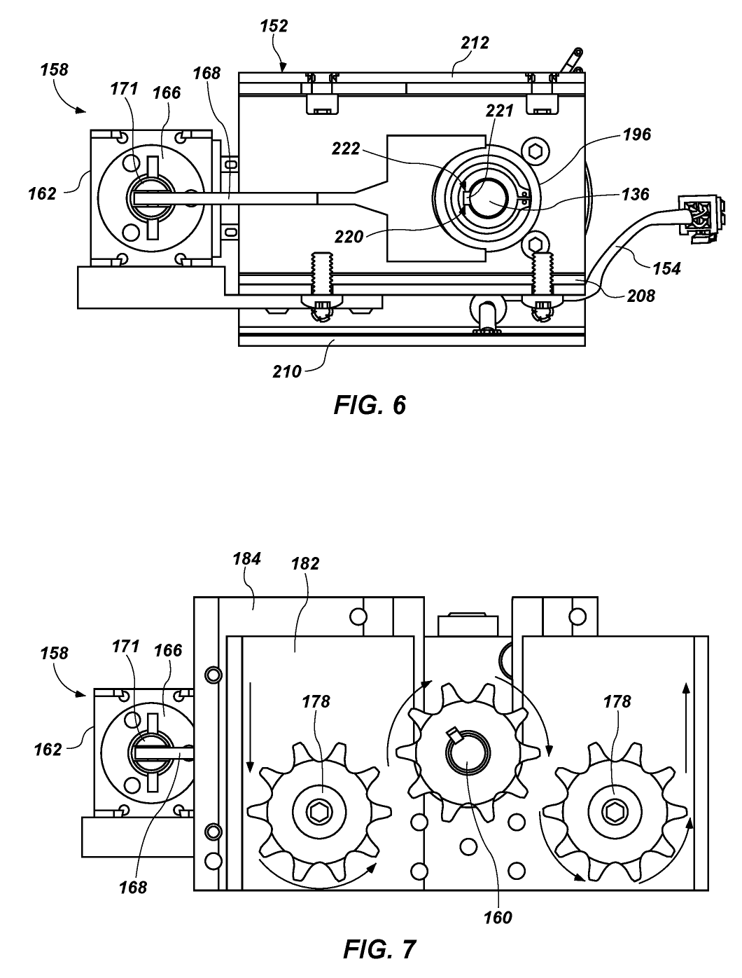

FIG. 6 is a cross-sectional top view of a portion of the drive assembly 150 of FIG. 3 taken along line A-A in FIG. 5. The drive shaft 136 of the motor 132 (see FIGS. 3-5) may include a radially extending keyway 220 and the first power transmission member 196 may include a corresponding keyway 222, each of which may be sized and shaped to receive a key 221. The first power transmission member 196 may be free to slide longitudinally (i.e., at least substantially parallel to an axis of rotation of the first power transmission member 196) along the drive shaft 136 responsive to movement of the lever member 168. The first power transmission member 196 may be driven rotationally by the key 221 between the drive shaft 136 and the first power transmission member 196.

FIG. 7 is a partial cutaway top view of the drive assembly 150 of FIG. 3 with the track 116 (see FIGS. 3-5) removed. The drive member 160 and tension members 178 may be arranged in a generally triangular pattern, with the drive member 160 located at a centrally located apex of the triangle and the tension members 178 located peripherally at a base of the triangle proximate a rear of the drive assembly 150. When engaging a continuous drive member 134 (see FIG. 2) with the drive member 160 of the drive assembly 150, the continuous drive member 134 (see FIG. 2) may extend laterally along a periphery of the top plate 184 in a first direction, around a first of the tension members 178 toward an opposite direction, around the drive member toward the first direction, around the other of the tension members 178 toward the opposite direction, and laterally along the periphery of the top plate 184 on an opposite side thereof in the opposite direction, as indicated by the arrows in FIG. 7.

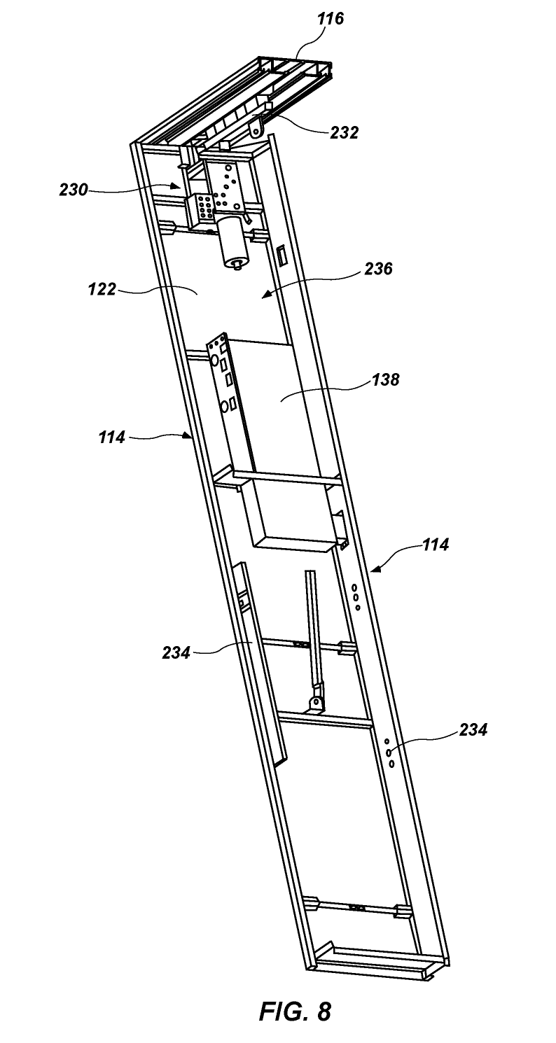

FIG. 8 is a perspective side view of another embodiment of a drive assembly 230 for a movable partition 102 (see FIGS. 1, 2). In some embodiments, such as that shown in FIG. 8, the drive assembly 230 may be carried by the lead post 122. More specifically, the drive assembly 230 may be suspended from a trolley 232 engaged with the track 116, from which trolley 232 the lead post 122 may also be suspended.

The lead post 122 may include a panel 236 positioned to form a leading surface of the partition 102 (see FIGS. 1, 2) and extending longitudinally from the trolley 232 to proximate the floor 120 (see FIG. 1). The lead post 122 may include hinges 114 at the horizontal peripheries of the panel 236 to affix panels 112 (see FIGS. 1, 2) of the first and second sheets 124 and 126 (see FIG. 2) to the lead post 122. The drive assembly 230 may be, for example, secured to the panel 236 of the lead post 122 (e.g., utilizing attachment hardware).

At least a portion of the control system 138 may be supported on the lead post 122 within the interior space 128 (see FIG. 2) of the partition 102 (see FIGS. 1, 2). For example, electronic components of the control system 138 operatively connected to, and configured to send instructions to, at least the disengagement mechanism 158 (see FIGS. 3-5), and optionally the motor 132 (see FIGS. 3-5) and/or the locking mechanism 216 (see FIGS. 3-5), may be supported on the lead post 122 within the interior space 128 (see FIG. 2) of the partition 102 (see FIGS. 1, 2).

In some embodiments, the lead post 122 may include one or more user input devices 234 configured to accept user input to alter operation of at least the drive assembly 230. For example, the user input devices 234 may be located proximate the hinges 114 of the lead post 122 and may be configured as handles or push-bars (e.g., crash bars) comprising switches that may send a signal to the control system 138, causing the control system 138 to place (or retain) the disengagement mechanism 158 in the engaged state for at least a predetermined period of time. In this way, a user proximate the door may interact with the user input device 234 to at least temporarily cause the motor 132 to at least partially retract the partition 102 (see FIGS. 1, 2), after which the control system 138 may cause the partition 102 to resume its previous operational status, such as, for example, extending from the retracted state to the extended state in the event of a fire. In other embodiments, the user input devices 234 may cause the control system 138 to place the disengagement mechanism 158 in the disengaged state for at least a predetermined period of time, temporarily enabling manual retraction of the partition 102 (see FIGS. 1, 2), after which the control system 138 may cause the partition 102 to resume its previous operational status, such as, for example, extending from the retracted state to the extended state in the event of a fire.

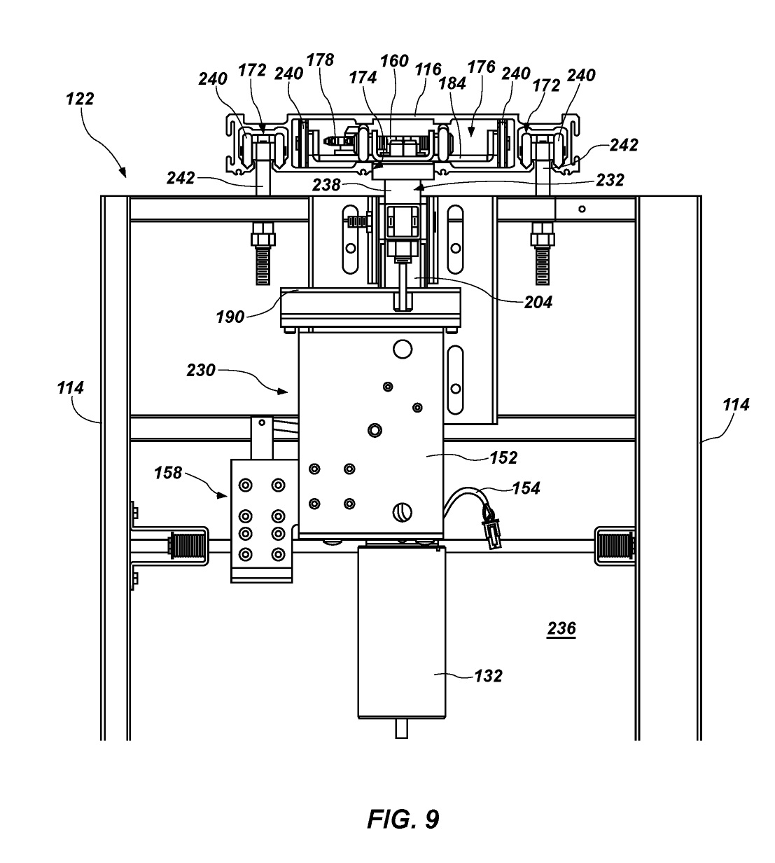

FIG. 9 is a partial front view of the drive assembly 230 of FIG. 8. The drive assembly 230 may be suspended from the trolley 232 by connecting the bottom plate 190 to a support member 238 extending longitudinally from the lower plate 190 toward the track 116. The support member 238 may extend longitudinally through the opening 174 to the central channel 176 of the track 116, and may terminate at the top plate 184. The top plate 184 may include rollers 240 rotatably secured to the top plate 184 at the horizontal periphery thereof, which rollers 240 may rest, and roll, on surfaces of the track 116 within the central channel 176 to slidably suspend the drive assembly 230 from the track 116 utilizing the trolley 232.

The lead post 122 may include brackets 242 extending longitudinally from the panel 236 toward the channels 172 at the periphery of the track 116. The brackets 242 may include, for example, bolts having nuts threadedly engaged with the bolts to secure the panel 236 to the brackets 242 and enable longitudinal adjustment of the height of the panel 236 relative to the floor 120 (see FIG. 1). Rollers 240 may be positioned at the ends of the brackets 242 opposite the panel 236 and within the channels 172 to slidably suspend the lead post 122 from the track 116 utilizing the trolley 232.

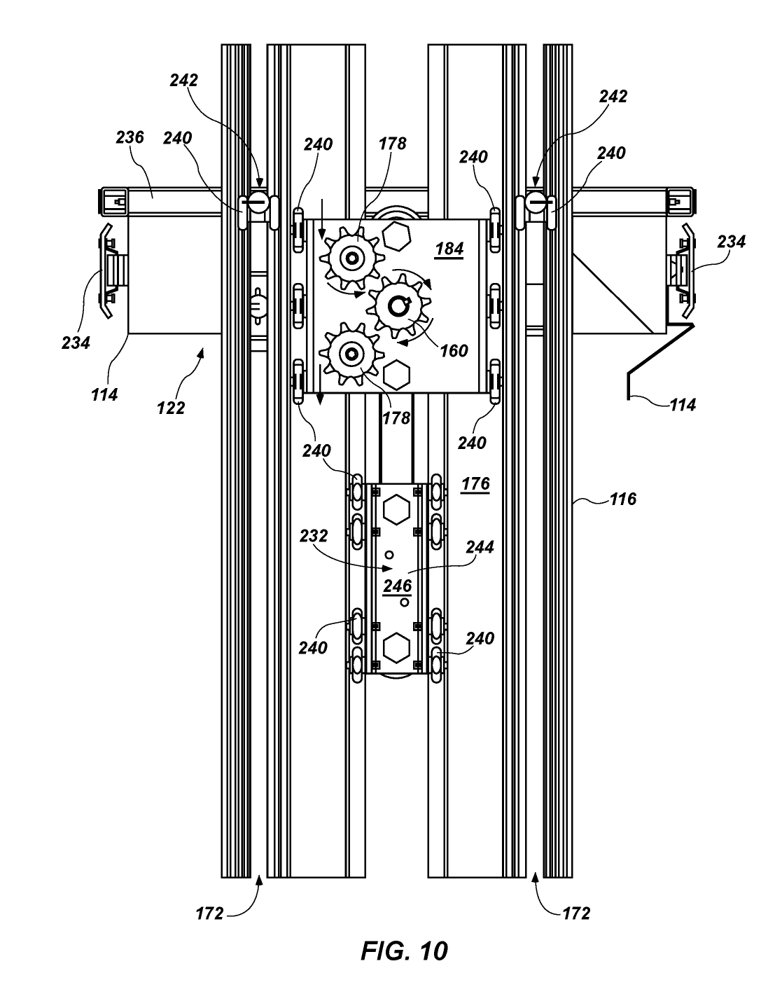

FIG. 10 is a partial cutaway top view of the drive assembly 230 of FIG. 8, particularly removing the top surface of the track 116. In addition to the top plate 184 and the brackets 242, the trolley 232 may include a stabilizer 244. The stabilizer 244 may include a plate 246 laterally spaced from the top plate 184 within the central channel 176 and connected to the support member 238 (see FIG. 9) of the trolley 232. The stabilizer 244 may include rollers 240 at the horizontal periphery thereof to rollingly engage with surfaces of the track 116. The provision of multiple sets of rollers 240, such as, for example, two rollers 240 on each bracket 242, six rollers laterally distributed along the top plate 184, and eight rollers laterally distributed along the stabilizer 244, may ensure that the trolley 232 has sufficient support capacity to rollingly bear the weight of the lead post 122 and associated components while reducing (e.g., eliminating) the likelihood that the trolley 232 or its rollers 240 will become misoriented within the track 116 and jam.

When engaging the continuous drive member 134 (see FIG. 2) with the drive member 160 and tension members 178 of this drive assembly 230 (see FIG. 8), the continuous drive member 134 (see FIG. 2) may extend laterally along a periphery of the central channel 176 in a first direction, around a first of the tension members 178 in an at least substantially perpendicular direction, around the drive member 160 to an at least substantially opposite direction, and around the second of the tension members 178 to the first direction, as shown by the arrows in FIG. 10.

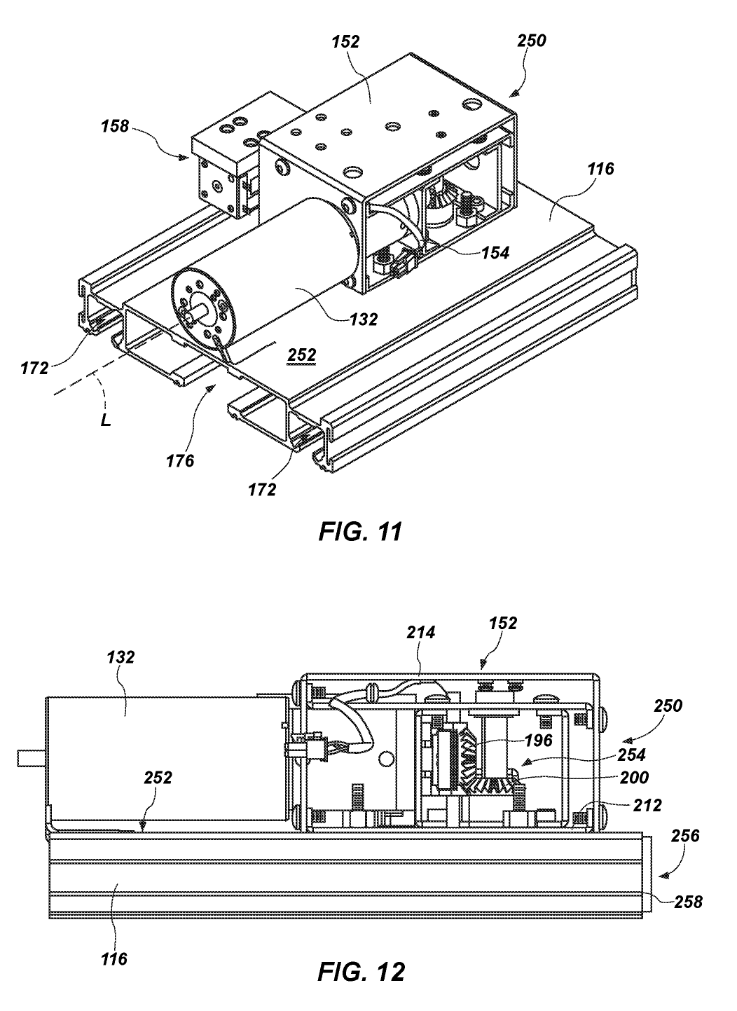

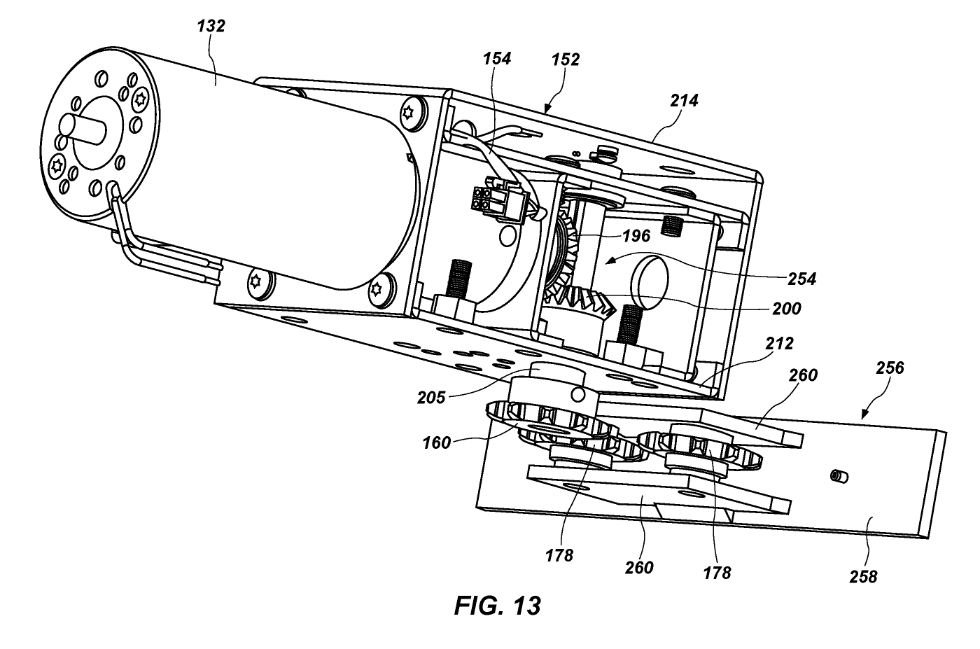

FIG. 11 is a perspective view of yet another embodiment of a drive assembly 250 for a partition system 100 (see FIGS. 1, 2). Unlike the drive assemblies 150 and 230 of FIGS. 3 through 10, each of which included a motor 132 (e.g., a drive shaft of the motor 132) having a longitudinal axis L oriented at least substantially vertically, the drive assembly 250 of FIG. 11 may be oriented such that the longitudinal axis L of the motor 132 (e.g., a drive shaft of the motor 132) extends at least substantially horizontally. The case 152 of the drive assembly 250 may be located vertically above, and may be supported on and secured to, an upper surface 252 of the track 116. Like the embodiments shown in FIGS. 3 through 10, the drive assembly 250 may include a disengagement mechanism 158 to selectively disengage the drive member 160 (see FIG. 13) from, and engage the drive member 160 (see FIG. 13) with, the motor 132.

FIG. 12 is a side view of the drive assembly 250 of FIG. 11. The power transmission mechanism 254 of the drive assembly 250 may lack the third power transmission member 202 (see FIG. 4), leaving only the first and second power transmission members 196 and 200.

FIG. 13 is a partial cutaway perspective side view of the drive assembly 250 of FIG. 11, particularly removing the track 116 (see FIG. 11). With combined reference to FIGS. 12 and 13, the second power transmission member 200 may be connected via the shaft 205 to the drive member 160 to transmit motive power from the motor 132 to the drive member 160 via the power transmission mechanism 254. The shaft 205 may extend through the sidewall 212 of the case 152, which may be supported on and connected to the upper surface 252 of the track 116 (see FIG. 11), through the track 116, into the central channel 176 (see FIG. 11).

A backstop assembly 256 may be sized, shaped, and positioned to cover a backside of the track 116 within the pocket 110 (see FIGS. 1, 2) and to support the tension members 178 within the central channel 176 (see FIG. 11). The backstop assembly 256 may include a plate 258 sized and shaped to cover a backside of the track 116, including the peripheral channels 172 (see FIG. 11) and the central channel 176 (see FIG. 11). Support members 260 may extend laterally from the plate 258 toward the central channel 176 (see FIG. 11) and the drive member 160 therein. The support members 260 may be sized, shaped, and otherwise configured to rotatably support the tension members 178 on the backstop assembly 256. For example, the support members 260 may include a pair of protrusions having a space defined therebetween in which the tension members 178 may be received, and the tension members 178 may be rotatably connected to the support members 260. A continuous drive member 134 (see FIG. 2) may be engaged with the drive member 160 and tension members 178 in at least substantially the same manner described previously in connection with FIG. 7.

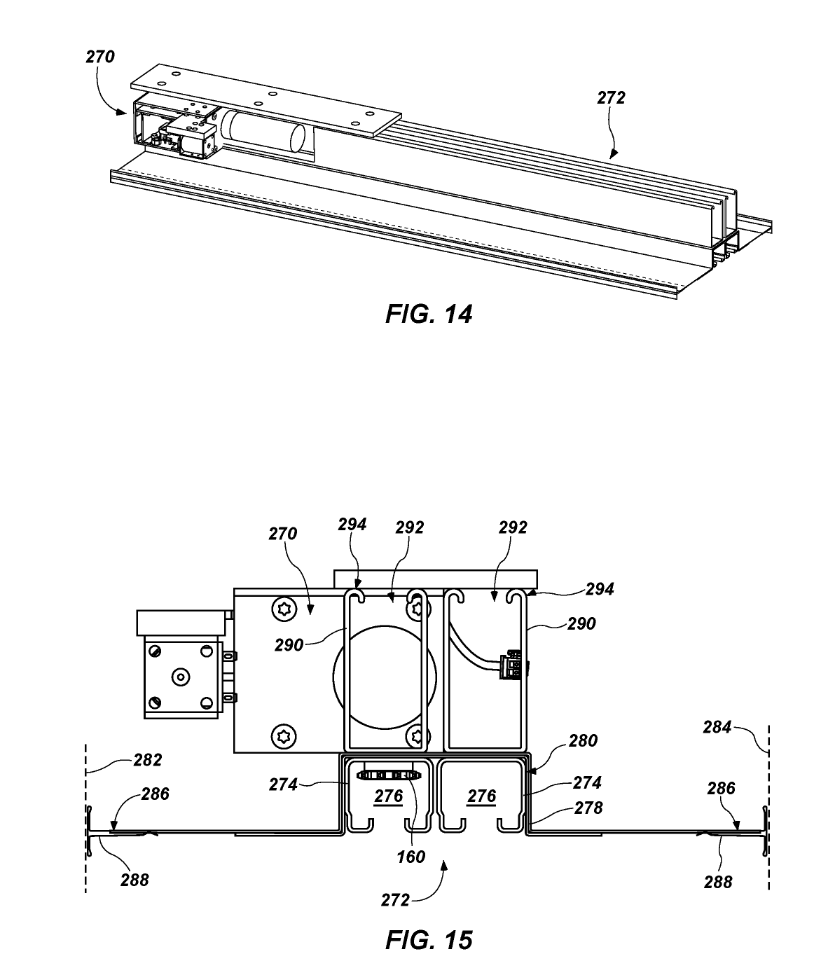

FIG. 14 is a perspective side view of still another embodiment of a drive assembly 270 for a partition system 100 (see FIGS. 1, 2). The drive assembly 270 itself may exhibit at least substantially the same configuration as the drive assembly 250 of FIGS. 11 through 13. The track 272 with which it is employed may differ from the track 116 of the previous embodiments.

FIG. 15 is a front view of the drive assembly 270 of FIG. 14. The track 272 may include, for example, a pair of “C” shaped members 274 comprising downward-facing channels 276. The “C” shaped members 274 may be located horizontally adjacent to one another, and may be sized, shaped, and otherwise configured to receive rollers to suspend the partition 102 (see FIGS. 1, 2) from the track 272. A header pan 278 may extend over the “C” shaped members 274 and may optionally form a channel 280 into which the “C” shaped members 274 may be received, the header pan 278 extending horizontally to peripheries of the “C” shaped members 274 and vertically downward along sidewalls of the “C” shaped members 274. The header pan 278 may extend horizontally outward toward walls 282 and 284 of an adjoining building structure (e.g., sidewalls 142 and 144 of a pocket 110 (see FIG. 2) or sidewalls of a header assembly). Horizontal peripheries of the header pan 278 may be received into recesses 286 of molding members 288, which may abut against, and optionally be secured to, the walls 282 and 284. Suspension members 290 may be located vertically above the header pan 278 on a side of the header pan 278 opposite the “C” shaped members 274. The suspension members 290 may include upward-facing openings 292 and engagement members 294 (e.g., hooks, loops) at upper ends of the suspension members 290 to enable the suspension members 290 to be suspended from a building structure, such as, for example, a laterally adjacent wall.

In such a configuration, the drive assembly 270 may lack the tension members 178 of FIG. 13. The continuous drive member 134 (see FIG. 2) may be located proximate one of the “C” shaped members 274 and may simply wrap around the drive member 160, which may be located within the same “C” shaped member 274 or cantilevered from a wall or ceiling adjacent to the “C” shaped member 274 and may lack beveling. For example, the continuous drive member 134 (see FIG. 2) may be entirely contained within one of the “C” shaped members 274 or may extend out from the “C” shaped member 274 to engage with the drive member 160.

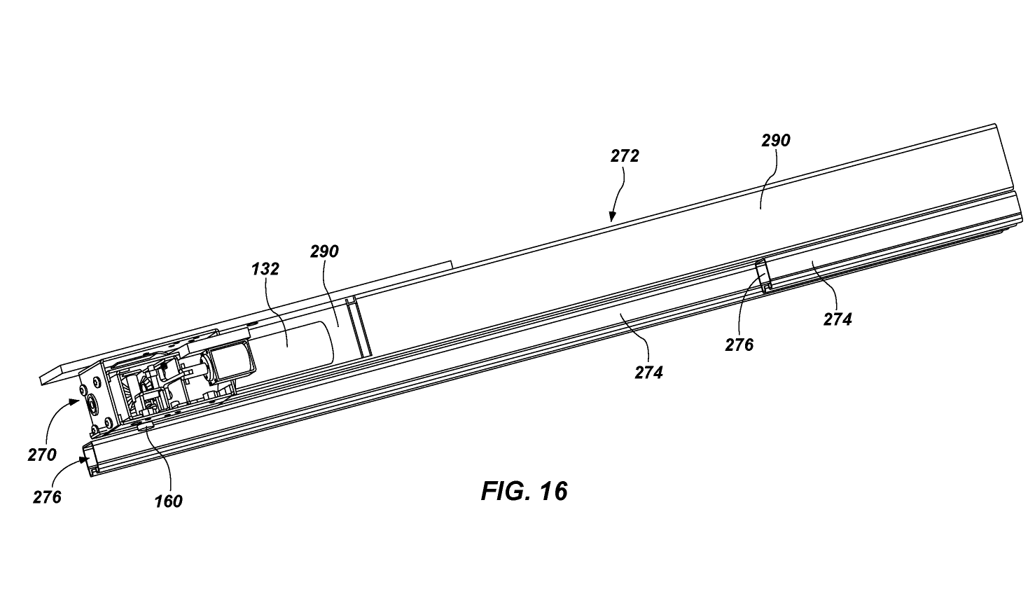

FIG. 16 is a partial cutaway side view of the drive assembly of FIG. 14. In some embodiments, components of the track 272 may be of different lengths. For example, each of the “C” shaped members 274 may be of a different length. More specifically, one of the “C” shaped members 274 that is free of the continuous drive member 134 (see FIG. 2) may be longer and may extend laterally for an entire length of the traversable distance of the partition 102 (see FIGS. 1, 2) and the other of the “C” shaped members 274 that may at least partially contain the continuous drive member 134 (see FIG. 2) may be shorter and may extend laterally for less than the entire length of the traversable distance of the partition 102 (see FIGS. 1, 2). As a specific, nonlimiting example, the drive member 160 may be located laterally beyond the extent of, and may be aligned with the channel 276 of, the corresponding shorter “C” shaped member 274. Similarly, each of the suspension members 290 may be of different lengths. More specifically, one of the suspension members 290 misaligned from the motor 132 may be longer and may extend laterally for an entire length of the traversable distance of the partition 102 (see FIGS. 1, 2) and the other of the suspension members 290 that may be at least partially aligned with the motor 132 may be shorter and may extend laterally for less than the entire length of the traversable distance of the partition 102 (see FIGS. 1, 2). As a specific, nonlimiting example, the motor 132 may be located laterally beyond the extent of, and may be aligned with, the corresponding shorter suspension member 290.

In summary, drive assemblies in accordance with this disclosure may enable functionality not previously practiced in the art, such as, for example, selective disengagement and locking of drive members, and may be usable in a greater variety of configurations and orientations with a greater variety of corresponding track configurations.

While certain illustrative embodiments have been described in connection with the figures, those of ordinary skill in the art will recognize and appreciate that the scope of this disclosure is not limited to those embodiments explicitly shown and described in this disclosure. Rather, many additions, deletions, and modifications to the embodiments described in this disclosure may be made to produce embodiments within the scope of this disclosure, such as those specifically claimed, including legal equivalents. In addition, features from one disclosed embodiment may be combined with features of another disclosed embodiment while still being within the scope of this disclosure, as contemplated by the inventors.

What is claimed is:

1. A drive assembly for a partition system, comprising:
a motor;
a power transmission mechanism operably coupled to a drive shaft of the motor, the power transmission mechanism comprising:
a first bevel gear rotatable by the drive shaft; and
a second bevel gear positioned for engagement with the first bevel gear, the second bevel gear comprising an axis of rotation oriented at least substantially perpendicular to an axis of rotation of the first bevel gear; and
a disengagement mechanism coupled to at least one of the first bevel gear or the second bevel gear and configured to selectively engage and disengage the first bevel gear and the second bevel gear.

2. The drive assembly for a partition system of claim 1, wherein the disengagement mechanism comprises:
an electric drive comprising an output shaft; and
a lever member secured to the output shaft of the electric drive at a first end thereof and to the first bevel gear at a second, opposite end thereof, the lever member rotatable about a fulcrum, the lever member configured to selectively move the first bevel gear in a direction at least substantially parallel to the axis of rotation of the first bevel gear responsive to movement of the output shaft.

3. The drive assembly of claim 1, wherein the power transmission mechanism comprises a third bevel gear engaged with the second bevel gear, the third bevel gear comprising an axis of rotation oriented at least substantially perpendicular to the axis of rotation of the second bevel gear.

4. The drive assembly of claim 3, further comprising a drive member drivable by the third bevel gear of the power transmission mechanism and configured to engage with a continuous drive member to extend and retract a partition, an axis of rotation of the drive member extending at least substantially parallel to the axis of rotation of the first bevel gear.

5. The drive assembly of claim 1, further comprising a drive member drivable by the second bevel gear of the power transmission mechanism and configured to engage with a continuous drive member to extend and retract a partition, an axis of rotation of the drive member extending at least substantially perpendicular to the axis of rotation of the first bevel gear.

6. The drive assembly of claim 1, further comprising a locking mechanism configured to selectively inhibit rotation of the second bevel gear, the locking mechanism comprising:
a locking member comprising teeth sized, shaped, and positioned to selectively engage with teeth of the second bevel gear; and
another electric drive configured to linearly drive the locking member to selectively engage with, and disengage from, the second bevel gear.

7. A partition system, comprising:
a track;
a partition suspended from, and slidable along, the track, the partition comprising panels interconnected by hinges; and
a drive assembly operably connected to the partition to extend and retract the partition, comprising:
a motor;
a power transmission mechanism operably coupled to a drive shaft of the motor, the power transmission mechanism comprising:
a first bevel gear directly rotatable by the drive shaft; and
a second bevel gear positioned for engagement with the first bevel gear, the second bevel gear comprising an axis of rotation oriented at least substantially perpendicular to an axis of rotation of the first bevel gear; and
a disengagement mechanism configured to selectively engage the first bevel gear and the second bevel gear and to selectively disengage the first bevel gear from the second bevel gear, the disengagement mechanism comprising:
an electric drive comprising an output shaft; and
a lever member secured to the output shaft of the electric drive at a first end thereof and to the first bevel gear at a second, opposite end thereof, the lever member rotatable about a fulcrum, the lever member configured to selectively move the first bevel gear in a direction at least substantially parallel to the axis of rotation of the first bevel gear responsive to movement of the output shaft.

8. The partition system of claim 7, wherein a longitudinal axis of the drive shaft of the motor is oriented at least substantially vertically.

9. The partition system of claim 7, wherein a longitudinal axis of the drive shaft of the motor is oriented at least substantially horizontally.

10. The partition system of claim 7, wherein the drive assembly is affixed to the track.

11. The partition system of claim 10, wherein a majority of the drive assembly is located vertically below the track.

12. The partition system of claim 10, wherein a majority of the drive assembly is located vertically above the track.

13. The partition system of claim 7, wherein the drive assembly is suspended from a trolley engaged with, and slidable along, the track.

14. The partition system of claim 13, wherein the drive assembly is secured to, and movable with, a lead post at an end of the partition.

15. The partition system of claim 14, further comprising at least one user input device proximate the lead post, the at least one user input device operably coupled to the disengagement mechanism and configured to cause the motor to at least partially retract the partition in response to a user input.

16. The partition system of claim 7, further comprising a drive member drivable by the power transmission mechanism and engaged with a continuous drive member to extend and retract the partition, an axis of rotation of the drive member extending at least substantially perpendicular to the axis of rotation of the first bevel gear.

17. The partition system of claim 7, wherein the power transmission mechanism comprises a third bevel gear engaged with the second bevel gear, the third bevel gear comprising an axis of rotation oriented at least substantially perpendicular to the axis of rotation of the second bevel gear.

18. The partition system of claim 17, further comprising a drive member drivable by the third bevel gear of the power transmission mechanism and engaged with a continuous drive member to extend and retract the partition, an axis of rotation of the drive member extending at least substantially parallel to the axis of rotation of the first bevel gear.

19. The partition system of claim 7, further comprising a drive member drivable by the second bevel gear of the power transmission mechanism and configured to engage with a continuous drive member to extend and retract the partition, an axis of rotation of the drive member extending at least substantially perpendicular to the axis of rotation of the first bevel gear.

20. The partition system of claim 7, further comprising a locking mechanism configured to selectively inhibit rotation of the second bevel gear, the locking mechanism comprising:
a locking member comprising teeth sized, shaped, and positioned to selectively engage with teeth of the second bevel gear; and
another electric drive configured to linearly drive the locking member to selectively engage with, and disengage from, the second bevel gear.
